(19) United States
(12) Patent Application Publication
(10) Pub. No.: US 2004/0228615 A1
(43) Pub. Date: Nov. 18, 2004

(54) System and method for controlling transmission of video and audio signals to at least one display device

(75) Inventor: Larry Eric Schultz, Winnipeg (CA)

Correspondence Address: DANIELS DANIELS & VERDONIK, P.A., SUITE 200 GENERATION PLAZA, 1822 N.C. HIGHWAY 54 EAST, DURHAM, NC, 27713, US

(73) Assignee: segOne, Inc., Coral Springs, FL

(21) Appl. No.: 10/438,599

(22) Filed: May 15, 2003

(51) Int. Cl. H04N 5/781

(52) U.S. Cl. 386/83; 386/125

(57) ABSTRACT

A system is connected real-time to a video source such as cable tv, satellite receiver, or off-air broadcast to receive video and audio signals to a final viewing screen or monitor. A tuning module breaks down the signal into composite audio-video signals to recognize when a commercial break has been inserted in the source video, to switch to an alternative channel of predetermined length before switching back to the original source. The alternative channel may include a connection to an audio and video source, for example such as a DVD player.

### BACKGROUND OF THE INVENTION

This invention relates to a system and method for controlling transmission of video and audio signals to at least one display device. More specifically, the invention relates to such a system and method, for example, for use in a closed system such as a closed cable system in which a video and audio feed is received and transmitted to multiple display devices such as televisions, for allowing substitution of a second video and audio feed in place of the first video and audio feed, for example, when commercials are being transmitted on the first video and audio feed.

With the current development of technology, a number of different programming options have become available to different types of users as it relates to video and audio feeds such as those transmitted through cable television systems, satellite systems, and off-air broadcasts or other forms of transmission. It should be appreciated that for purposes of the disclosure herein the term “broadcast signals” and “video” and “audio” signals refers to all of these types of transmissions, and more generally known as radio frequency (RF) video and audio signals.

Recipients of these type of signals include a number of different types of consumers. Among these consumers are individual homeowners or apartment renters who may either be directly connected to the local cable system, receive signals as part of off-air broadcasts through conventional television transmissions, satellite signal antennas, etc. In the case of apartment dwellers, it is often the case that the owner of the apartment building will contract directly with the local cable provider and provide a closed feed to all of the units in the apartment building. All of these types of consumers are limited to viewing only what the broadcaster provides on a channel, unless they physically take the affirmative steps of changing channels.

Other types of consumers may involve specialty facilities such as private companies which may find it desirable to provide such programming in the form of video and audio signals to one or more display units such as television set monitors, etc. distributed throughout the private facility. In such an environment, depending on the configuration, one or more channels are transmitted to one or more display units distributed throughout the private facility.

In all of these cases, the programming and associated video and audio signals typically include established programming breaks in the form of commercials or other content, which under current standards typically last at least about one and one-half minutes.

In the case of establishments such as private corporations where a video and audio feed may be purchased for distribution to display units throughout the organization within their own closed circuit loop, it often becomes desirable to substitute customized commercial programming for that being transmitted as part of the regular programming on at least one channel. In this case, the transmission occurs within a closed circuit as a closed circuit transmission. However, a problem with attempting to substitute such private commercial programming with that received as part of a regular feed has been that there was no way to ensure that the original programming was switched on again in a manner which did not interrupt the entertainment programming portion of transmission.

In accordance with the system and method described herein, these problems are avoided in a manner which ensures integrity of the entertainment programming portion of the feed, while allowing substitution of selected content in place of the content breaks and content substitution, such as commercials, transmitted with the original video and audio feed.

### SUMMARY OF THE INVENTION

In accordance with one aspect of the invention there is provided a system for controlling transmission of video and audio signals to at least one display device. As noted previously, the display device can be one or more of several types of devices including monitors, standard television sets, etc. Means for connecting to a first source of video and audio signals transmitted on at least one channel is provided. The means can include, among others, conventional input jacks. A tuner serves to tune the system to a channel of the first source of video and audio signals. There is also provided means for connecting to at least one display device for conveying the video and audio signals from the first source on the channel to at least one display device. The means for connecting can include, for example, an output jack with associated cable connecting to the display device which can be a monitor, television, etc. A second source of video and audio signals is connected for transmitting audio and video signals to at least one display device on a channel separate from that of the first source, and processing circuitry is provided for breaking down the audio and video signals from the first source into composite video and audio signals. The processing circuitry includes detecting means, such as a level sensor, for detecting when the audio signals from the first source has dropped below a predetermined level and when the video signal has gone to about black. Control means, such as a microprocessor control with appropriate programming is provided for having the output switch to the second source of audio and video signals, for having the audio and video signals from the second source transmitted on the separate channel to the display device.

Typically, the second source is a player such as a digital versatile disk (DVD) player. However, the second source can come from various devices such as a disk drive, flash memory or other types of storage memory. The processing circuitry, as noted previously, is configured for detecting a break in content, such as a commercial break or other content substitution, which corresponds to the drop in the audio signal below a predetermined level, and the composite video signal going to about black, and for switching to the second source of video and audio signals when the content break is detected. For purposes of this disclosure, it should be noted that about black means typically about 20%, preferably about 15%, where 0% is total black and 100% is total white. Although a typical value for about black has been given, it will be appreciated by those of ordinary skill in the art that “about black” corresponds to any value indicative of a break in the programming such as for a commercial break.

In another aspect, there is provided a method of controlling transmission of video and audio signals to at least one display device. The method includes the steps of receiving video and audio signals from a first source of video and audio signals transmitted on at least one channel, through a control device which includes a second source of video and audio signals, and which is connected for conveying video and audio signals to at least one display device. The video and audio signals from the first source are conveyed to at least one display device, and are also broken down into composite video and audio signals. The audio and composite video signals are monitored and a drop of the audio signal below a predetermined level and the composite video signal going to about black is detected. When such detection occurs, the method includes switching to the second source of video and audio signals for a predetermined period of time.

### BRIEF DESCRIPTION OF THE SEVERAL VIEWS OF THE DRAWINGS

Having thus briefly described the invention, the same will become better understood from the following detailed discussion presented with reference to the drawing wherein:

FIG. 1 is a block diagram overview of a system in accordance with the invention;

FIG. 2 is a block diagram of one embodiment of the system in accordance with the invention, showing specific features thereof in greater detail than the block diagram of FIG. 1;

FIGS. 3a and 3b is a flow chart illustrating the overall operation of the system and method described herein;

FIG. 4 is a flow chart illustrating the start up configuration of the microprocessor unit upon AC power up;

FIG. 5 is a flow chart illustrating the start up operation for the power supervisor board described herein;

FIG. 6 is a flow chart illustrating how the system breaks to a second video and audio source, namely DVD player;

FIGS. 7a and 7b is a flow chart illustrating how the system breaks back to the first video and audio feed from the second video and audio feed, i.e., back to network.

### DETAILED DESCRIPTION OF THE INVENTION

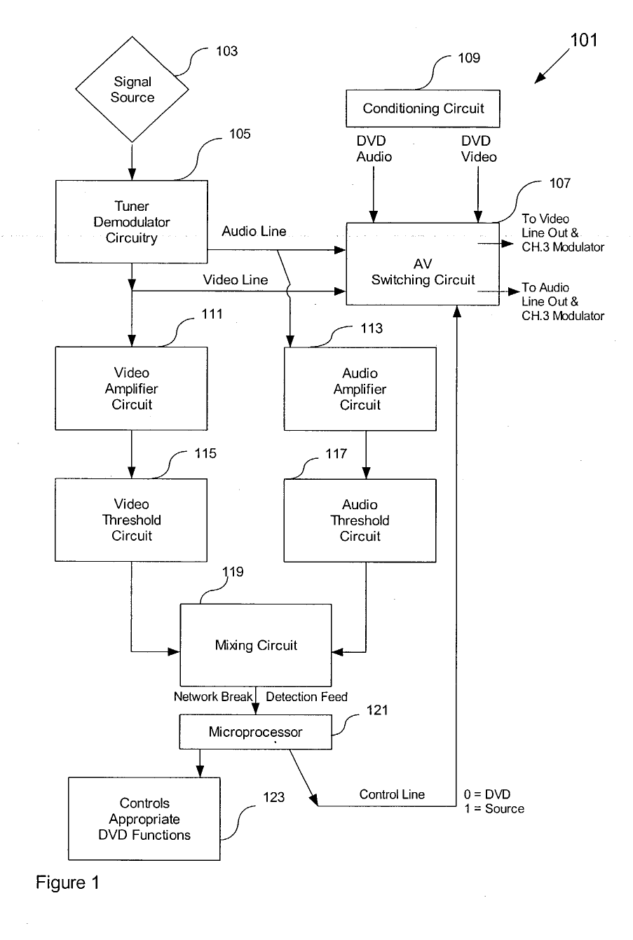

FIG. 1 is a high-level block diagram 101 of the system in accordance with the invention. In a more specific aspect, a conventional digital versatile disk (DVD) player is modified to receive signals, specifically video and audio signals, and more specifically radio frequency (RF) video and audio signals, and transmit them to a receiver such as a television set. The system 101 is further configured for selectively switching channels and interrupting the feed from an external signal source 103, such as a cable, satellite, or off-air source, to selectively deliver content on a separate channel from a DVD loaded into the player. Under normal circumstances, upon receipt of normal programming signals from a signal source 103, a conventional tuner demodulator circuitry 105 passes the audio and video portions of the signals through an audio line and a video line to an audio-video switching circuit 107 which is connected to the DVD deck through a conditioning circuit 109. The audio and video signals are transmitted through the audio-video switching circuit 107 respectively to video line out and to audio line out and CH3 modulator.

The audio and video signals which are received from the signal source 103 are also passed, respectively, to a video amplifier circuit 111 and an audio amplifier circuit 113 through which they are amplified in a conventional manner and passed to, respectively, video threshold circuit 115 and audio threshold circuit 117. The video threshold circuit 115 serves to determine when the video signal goes to about black, which may be indicative of a change in content such as a commercial break. The audio threshold circuit 117 detects whether the audio portion of the signal drops below a predetermined level. This information is transmitted through respective lines to the mixing circuit 119, and if both events occur, that information is transmitted to a microprocessor 121 which operates in combination with a DVD control circuit 123 implementing appropriate DVD operation functions to transmit a signal through a control line to the audio-video switching circuit to switch the channel from the incoming signal source 103 channel to the DVD signal source 109. At this time the DVD player has initiated play through the control circuit 123 to transmit DVD signals through the conditioning circuit 109 to the audio-video circuit 107 to at least one display device connected to the system.

Thus, when a break is detected, such as when the audio drops below a predetermined level and the video goes to about black, the system switches to the DVD player to deliver a prerecorded program, for example, a different content such as a commercial, to the receiver through the audio-video switching circuit 107. So that the regular programming from the signal source is typically not interrupted, the programming delivered from the DVD player is optionally limited to about 30 seconds and not more than about 2 minutes, i.e., 120 seconds. This length of time is determined from the fact that under current programming protocols, most breaks in content such as commercials run for about one and one-half minutes. However, as may be appreciated, the amount of time during which the DVD signals are delivered may be varied in accordance with various other aspects.

With respect to the amount of drop in the sound level, the predetermined level is typically about when the sound is silent. The DVD player by prior command of the microprocessor 121 has been waiting in the pause mode and waiting to play a track of predetermined length. In order to make the transition appear to be seamless to the viewer, the first few frames on the disk have been recorded in black. The conditioning circuit 109 preconditions the audio and video signal output level so that they match the levels of the source video and audio signal from the signal source 103. Several frames of black are also recorded onto the disk at the end of the track that is to be played. The processing function provided by the microprocessor 121 recognizes this as being the end of the track and delays the switchback to the source video by a predetermined amount of time, typically 0.1 seconds to allow what is perceived as a smooth transition back to source audio and video from the signal source 103.

In order to ensure that an additional switch to the DVD player does not occur, the system is programmed through the microprocessor 121 to ignore any drop to “about black” in the source video for a predetermined length of time, typically approximately four and one-half minutes to ensure that source breaks have passed and the source is back to the desired program material.

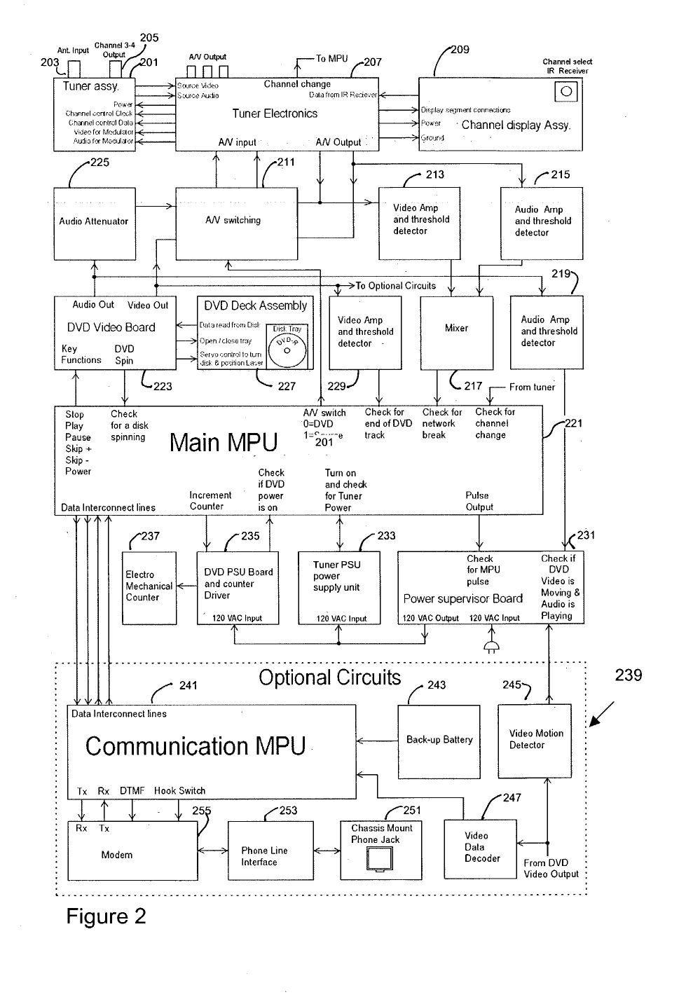

In a more specific and detailed implementation, the system according to the invention is shown in greater detail in FIG. 2. The system of FIG. 2 includes a conventional tuner assembly 201 which receives (RF) audio and video signals which can come in through, for example, an antenna input 203. The input 203 can be for an antenna, cable, satellite, or any other type of source. The tuner assembly 201 includes a modulator built in, and an output is provided through an output jack 205 which can be set to switch between channels 3 and 4 in a conventional manner well known to those of ordinary skill in the art. Thus, through the tuner assembly 201 the incoming programming can be delivered to one or multiple audio-video devices, such as televisions, monitors, etc. The tuner assembly 201 is also connected to tuner electronics 207 which through input by an end user can be used to select which channel the end user wants to view on the antenna input. The tuner electronics 207 at the same time displays on a LED display on the front panel the channel signal coming into the tuner assembly 201. More specifically, when a channel signal comes into the tuner assembly 201, the audio and video is broken down and goes from the tuner assembly to the tuner electronics 207 through appropriate connections as shown in FIG. 2. Simultaneously, this signal passes through appropriate connections to the channel 3-4 modulated output 205 on the tuner assembly as shown in FIG. 2. The audio video outputs from the audio video switched circuit 211 go through the tuner electronics 207. This provides audio-video output on the audio-video jacks on the tuner electronics.

In operation the audio and video signals into the tuner electronics 207 is also transmitted through the audio-video output shown to video amplifier and threshold detector 213 and audio amplifier and threshold detector 215.

As noted previously, the video amplifier and threshold detector 213 detects when the video signals goes to about black, which for purposes of the system described herein is anything below about 20% black, typically below about 15% black. With respect to the audio amplifier and threshold detector 215, the system detects whether the audio signal has gone to silent. These signals are passed to mixer 217 which, when both events occur, transmits to the main microprocessor unit (MPU) 221 an indication that there is a network break. As may be appreciated from the various connections shown with respect to the MPU 221, it also serves to provide control signals to DVD video board 223 which controls the DVD deck assembly 227 and monitors the deck assembly 227 spin to ensure proper operation. When a network break is detected by mixer 217, the MPU 221 sends a signal to audio-video switching circuit 211 to switch to DVD video and audio source. The audio and video signals from the DVD deck assembly 227 are transmitted through the DVD video board through an audio attenuator 225 which sets the audio at the same level as the original incoming signal at input 203, and with video being passed directly to the audio-video switching circuit 211 to be passed therethrough to the display device as connected to the system of FIG. 2. The MPU 221 also checks for the change in channel through a signal which is received from the tuner electronics 207 and passed to the MPU 221 to perform appropriate preprogrammed functions as described in greater detail hereinafter.

In order to provide power and control, a power supervisor board 231 is connected to a source of 120 volt AC power. Power is provided by the system to various elements of the DVD player, namely an electromechanical counter 237, a DVD power supply unit (PSU) board and counter driver 235, and a tuner power module 233 connected to the MPU 221.

Optionally, the power supervisor board 231 can be further modified for connection to an optional circuit 239 which can provide additional functionality to the system.

In one aspect, the optional circuit 239 includes a video motion detector 245 which provides signals to the power supervisor board 231 which in combination with signals from the audio amplifier and threshold detector 219 can provide an indication of whether the DVD video is moving and the audio is playing. If a lack of movement or playing is detected, the MPU 221 may be programmed to reboot the entire system. In this regard, the video motion detector 245 interprets video output from the DVD 227, which is used to provide the information to power supervisor board 231 to detect if there is a problem with the DVD 227 video flow. Optional circuit 239 includes a communication microprocessor unit (MPU) 241 which will be connected in a manner as to allow the transfer of information through a modem/telephone interface circuit to an external device, which may include a telephone jack 251, a telephone line interface 253, and a modem 255. The external device may capture, store, and manipulate transmitted data as required by the system of FIG. 2.

In addition, the communications MPU 241 also keeps track of content breaks such as commercial break information supplied to it from the main MPU 221 via the data interconnect lines. The break information may be stored in non-volatile memory located on the communications MPU 241. Information which may be stored may include items such as (1) time inserted video was played, (2) advertisement sequence ID codes as may be required for future proof of performance verification and other internal uses. Error alarms may also be transmitted as required. This additional functionality may provide additional information to manage the system, determine commercials play time, establish rates, etc. The modem 255 and MPU 241 can be used to connect to a network to download content to the storage devices, and to upload information on time insert video was played, number of times video was played, and other stored information as described herein.

The communications MPU 241 may be connected to a backup battery 243, and information is temporarily stored in RAM and sent to EEROM after 100 commercial breaks. In case of power failure, the battery 243 will supply enough power to transfer the data to the EEROM.

Having thus described in detail a specific implementation of the system of the invention, operation thereof will become better understood from the following discussion.

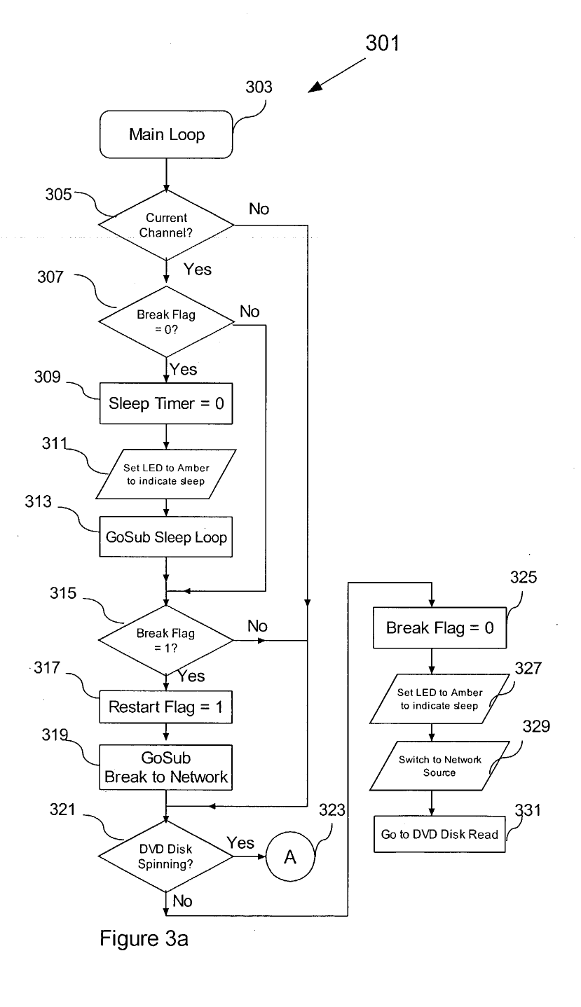

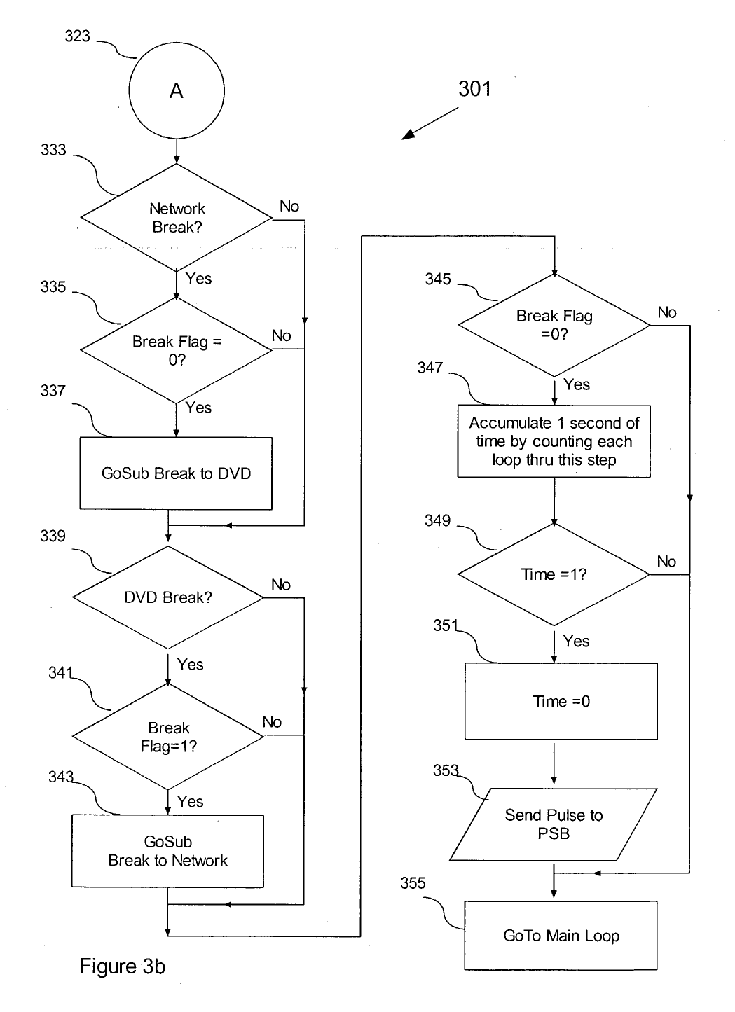

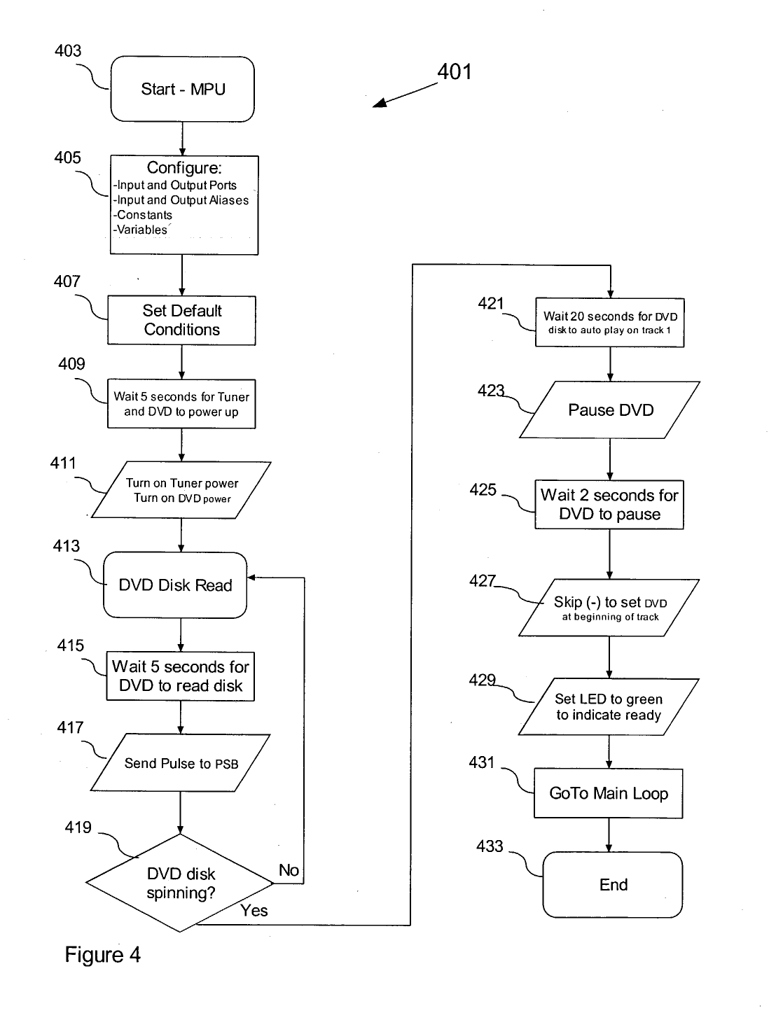

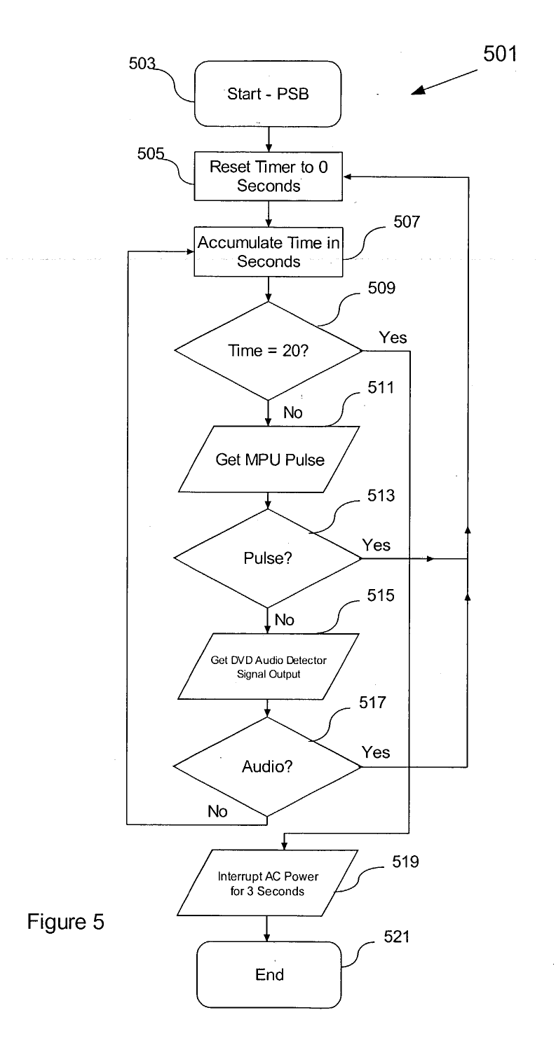

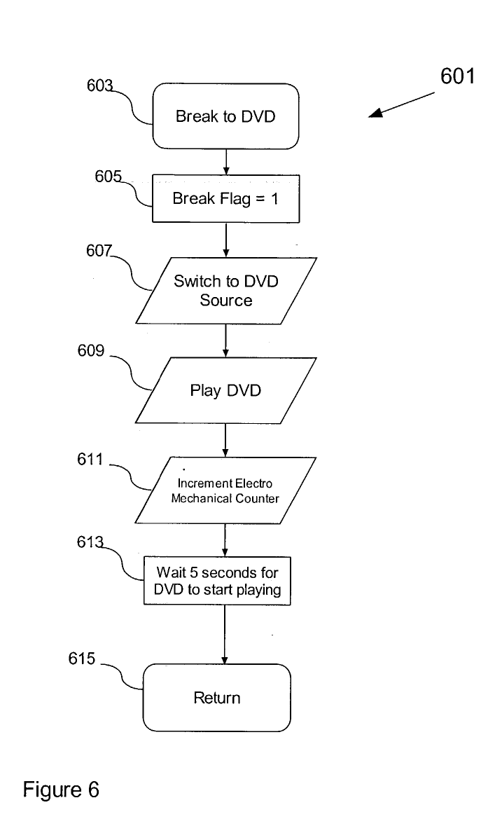

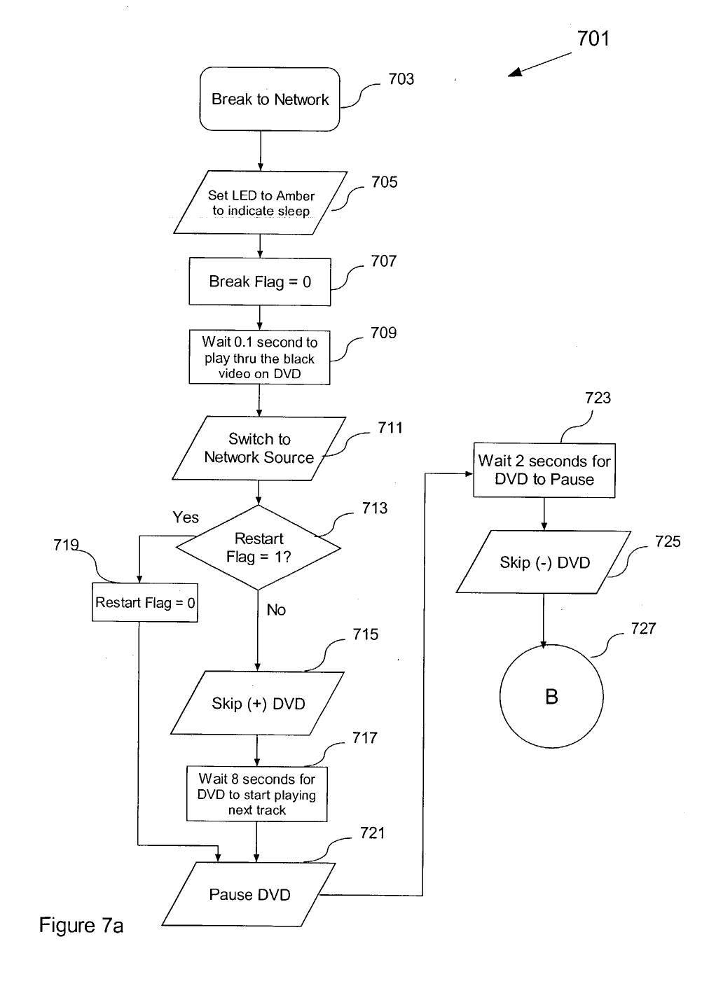

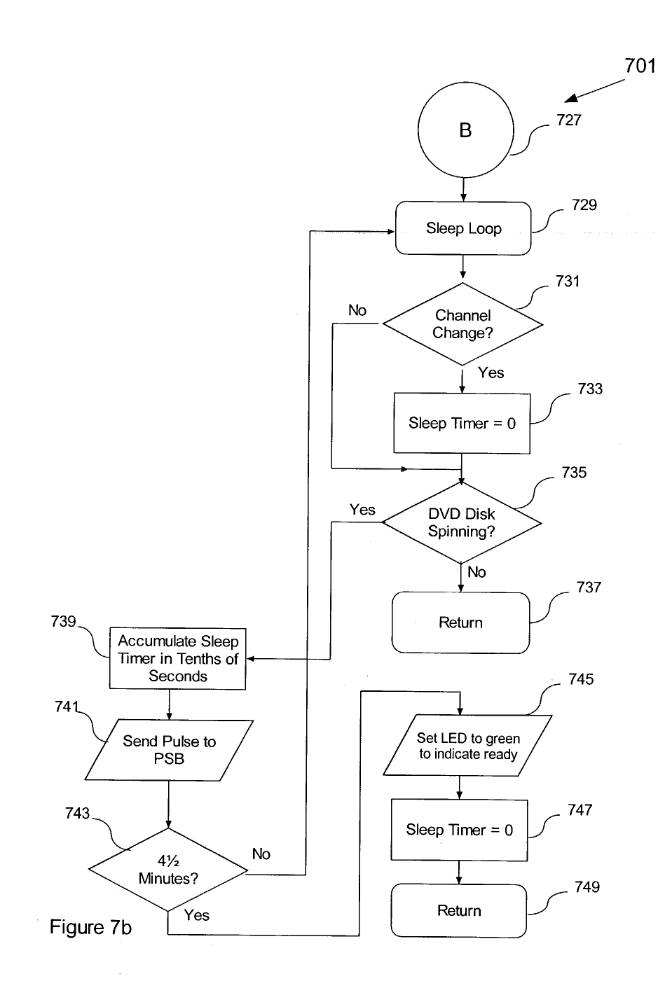

Turning now to operation of the system, it is noted that the operation is illustrated herein by FIGS. 3a-7b. These figures are flow charts indicating operation of the system. FIG. 3a-b is a flow chart 301 generally showing the overall operation of the system. FIG. 4 is a flow chart 401 illustrating what occurs upon power up when the DVD and tuner are on standby, and illustrating how the main MPU 221 re-sets and the program begins. FIG. 5 is a flow chart 501 illustrating what occurs with the power supervisor board 231 on AC power up. FIG. 6 is a flow chart 601 illustrating what occurs when the system breaks to the DVD player upon detection of a break. FIGS. 7a and 7b are a flow chart 701 illustrating what occurs at the end of the DVD player transmission, and the break back to the incoming original signal.

In accordance with the flow chart 301 of FIG. 3a-b, the system operates at the start of a main loop 303. A determination is made at step 305 as to whether the user is actively in the process of changing a channel. If the answer is no, the system goes to step 321 to determine whether the DVD disk is spinning. If the DVD disk is not spinning, at step 325 the break flag is set to zero, and an LED on the unit is set to amber at step 327 to indicate sleep mode for the DVD player. Thereafter, the system switches to the network source 329 and goes to DVD disk read 413 at step 331.

If at step 305, the indication is that the user is in the process of actively changing the channel, then, at step 307 the system checks to see if the break flag is equal to zero. If the answer is yes, the system goes to step 309 and sets the sleep timer at zero, and at step 311 sets the LED to amber to indicate sleep, and the system at step 313 goes to a sleep loop 729. If the answer is no, at step 307 the system goes to step 315 where a determination is made as to whether the break flag is equal to 1. If the answer is yes, at step 317 the restart flag is set to 1, and at step 319 the system goes to the sub-routine 703 which causes a break to the network or first audio and video signal feed.

If at step 315 it is indicated that the break flag is not set to 1, then the process goes to step 321 as before. At step 321, if it is determined that the DVD disk is spinning, then the system passes to circle 323 in FIGS. 3a and 3b and a determination is made at step 333 as to whether there is a network break. If the answer is no, the system proceed to step 339 where it is determined whether there is a DVD break. If the answer at step 339 is no, then the system proceeds to step 345 where it is determined whether the break flag is set to zero. If the answer is no, the system then proceeds to step 355 to return to the main loop 303. If the answer at step 333 is that there is a network break, then at step 335 a determination is made as to whether the break flag is set to zero. If the answer is no, then the system or process proceeds to step 339 as before. If the answer is yes, then the system proceeds to step 337 to the sub-routine to break to the DVD player 603. At step 339 a determination is made as to whether there is a DVD break, and if the answer is no the system proceeds to step 345 as before. If the answer is yes, then at step 341 a determination is made whether the break flag is set to 1. If the answer is no, as before, the system proceeds to step 345. If the answer is yes, at step 343 the system goes to the sub-routine controlling the break to the network 703, i.e., the initial audio and video input coming from the tuner assembly.

As previously discussed, at step 345 a determination is made whether the break flag is equal to zero. If the answer is yes, at step 347 the system accumulates one second of time by counting each loop through 347. At step 349 a determination is made if the time is equal to 1, and if the answer is no the system proceeds to step 355 to go to the main loop 303. If the answer is yes, at step 351 the time is set equal to zero and at step 353 a pulse is sent to the power supervisor board 231 and the system then returns to step 355 to go to the main loop 303.

FIG. 4 illustrates a flow chart 401 which indicates what happens with the microprocessing unit 221 upon power up. At step 403 the microprocessing unit 221 is started. At step 405 the input and output ports, input and output aliases, constants, and variables are configured. Step 407 sets the default condition and at step 409 the system pauses for about five seconds for the tuner and DVD deck to power up.

At step 411 the tuner power and the DVD power are turned on. At step 413 the disk in the DVD deck 227 is read and at step 415 the system is paused or waits for five seconds for the DVD deck to read the disk. At step 417 a pulse is sent to the power supervisor board 231, and at step 419 an inquiry is made as to whether the DVD disk is spinning. If the answer is no, the system returns to 413 and proceeds as before. If the answer is yes, the system then goes to step 421 and waits 20 seconds for the DVD disk to autoplay on track 1. At step 423 the DVD is paused, and step 425 waits 2 seconds for the DVD to pause. At step 427 the DVD player skips to set the DVD at the beginning of the track and at step 429 the LED is set to green to indicate the system is ready. At step 431 the system goes to the main loop 303 to be operated as described previously. The end of this section of the program is indicated at step 433 in FIG. 4.

FIG. 5 is a flow chart 501 illustrating what happens with the power supervisor board 231 upon AC power up. More specifically, at step 503 the power supervisor board 231 starts up. At step 505 the timer is re-set to zero seconds, and at step 507 time is accumulated in seconds. At step 509 if the time is equal to 20, the system proceeds to step 519 to interrupt the AC power for 3 seconds, therefore causing the whole system to reset, and thereafter to the end of the routine 521. If the answer is no, at step 511 the microprocessor 221 pulse is obtained. At step 513 a determination is made whether the pulse was received and if the answer is yes, the system proceeds back to step 505 to re-set the timer as before. If the answer is no, the system proceeds to step 515 to obtain the DVD audio detector signal output. If audio is detected at step 517, the system returns to step 505. If no audio is detected, the system proceeds back to step 507 as before.

FIG. 6 illustrates a flow chart 601 which shows how the break to DVD occurs. At a step 603, when sent from gosub break to DVD 337 of main loop 301, the subroutine break to the DVD player occurs. At step 605 the break flag is set to 1, and at step 607 the system switches to the DVD video and audio source. The DVD disk is played at step 609 and the electromechanical counter is incremented at step 611. At step 613 the system waits 5 seconds for the DVD disk to start playing, and thereafter returns at step 615 to DVD break 339 of main loop 301.

FIG. 7a-b shows a flow chart 701 illustrating how a break to network occurs after the DVD has played. This may occur from either gosub break to network 319 or gosub break to network 343 of main loop 301. The first step involving the break to network 703 passes to a step 705 where the LED is set to amber to indicate sleep mode. At step 707 the break flag is set equal to zero, and at step 709 the system waits about 0.1 seconds to play through the black video on DVD. Thereafter, at step 711 the system switches to the network source, i.e., the original input.

At step 713, a determination is made whether the restart flag is equal to 1. If the answer is no, the system at step 715 skips forward on the DVD and at step 717 waits 8 seconds for the DVD to start playing the next track. If at step 713 the answer is yes, then at step 719 the restart flag is set equal to zero, and either from step 719 or step 717, at step 721 a command is issued to pause the DVD. At step 723 the system waits 2 seconds for the DVD to pause, and at step 725 skips backwards on the DVD and proceeds to step 727 which is a connector to FIG. 7b. At step 729 the sleep loop is entered, and at step 731 a determination is made whether the user is actively in the process of changing a channel. If the answer is yes, at step 733 the sleep timer is set equal to zero. If the answer is no, the system proceeds to step 735, either from step 731 or 733, to determine whether the DVD disk is spinning. If the answer is no, then the system returns at 737 to main loop 301, and if the answer is yes then at step 739 the system accumulates sleep timer in tenths of seconds, and at step 741 sends a pulse to the power supervisor board.

At step 743 a determination is made about whether about four and one-half minutes have passed, and if the answer is no, the system returns to sleep loop 729. If the answer is yes, then at step 745 the LED is set to green to indicate ready, and at step 747 the sleep timer is set equal to zero. The system returns at step 749 back to main loop 301.

Having thus generally described the invention, the same will become better understood from the following claims in which it is set forth in a non-limiting manner.

1. A system for controlling transmission of video and audio signals to at least one display device, comprising:
means for connecting to a first source of video and audio signals transmitted on at least one channel;
a tuner for tuning the system to a channel of said first source of video and audio signals;
means for connecting to said at least said one display device for conveying said video and audio signals from said first source on said channel to said at least one display device;
a second source of video and audio signals connected for transmitting audio and video signals to said at least one display device on a channel separate from that of said first source; and
processing circuitry for breaking down said audio and video signals from said first source into audio and composite video signals, said processing circuitry including detecting means for detecting when the audio signals from said first source has dropped below a predetermined level and when the composite video signal has gone to about black, and means for having said tuner switch to said second source of audio and video signals for having said audio and video signals from said second source transmitted on said separate channel to said at least one display device.

2. The system of claim 1, wherein said second source of video and audio signals comprises a player for a stored source of video and audio signals.

3. The system of claim 2, wherein said player comprises a digital versatile disk (DVD) player.

4. The system of claim 1, wherein said second source of video and audio signals comprises at least one of a disk drive, flash memory or other type of storage memory.

5. The system of claim 1, wherein said means for connecting to said first source of video and audio signals is adapted for receiving at least one of cable, satellite and air broadcast video and audio signals.

6. The system of claim 5, wherein said means for connecting to said first source is adapted for receiving said video and audio signals as RF video and audio signals.

7. The system of claim 1, wherein said processing circuitry is configured for detecting a commercial break in the video and audio signals from said first source, and for switching to said second source of video and audio signals when said commercial break is detected.

8. The system of claim 7, wherein the processing circuitry is configured for controlling said second source of video and audio signals to convey the video and audio signals from the second source to said at least one display device for a predetermined period of time calculated to be approximately no more than about the time for the commercial break.

9. The system of claim 7, wherein said processing circuitry is further configured for switching the tuner back to said first source of video and audio signals after said predetermined period of time elapses.

10. The system of claim 3, further comprising a video motion detector for monitoring video output of the player, and further comprising means for rebooting the player in the event a frozen video is detected.

11. The system of claim 1, wherein said processing circuitry further comprises a processing unit, memory and software stored therein for controlling switching between the first source of video and audio signals and the second source of video and audio signals.

12. A method of controlling transmission of video and audio signals to at least one display device, comprising:
receiving video and audio signals from a first source of video and audio signals transmitted on at least one channel, through a second source of video and audio signals which is connected for conveying video and audio signals to said at least one display device;
conveying the video and audio signals from the first source to said at least one display device, and breaking down said audio and video signals from said first source into audio and composite video signals;
monitoring said audio and composite video signals and detecting when the audio signal from said first source has dropped below a predetermined level and when the composite video signal has gone to about black; and
switching to said second source of video and audio signals when said audio signal from said first source has dropped below a predetermined level and when the composite video signal has gone to about black, and conveying said video and audio signals from said second source to said at least one display device for a predetermined period of time.

13. The method of claim 12, wherein said second source of video and audio signals comprises a player for a stored source of video and audio signals.

14. The method of claim 13, wherein said player comprises a digital versatile disk (DVD) player.

15. The method of claim 12, wherein said first source of video and audio signals is at least one of a cable source, satellite source, and air broadcast source.

16. The method of claim 15, wherein said video and audio signals from said first source are RF video and audio signals.

17. The method of claim 12, wherein said detecting of when the audio signal has dropped below a predetermined level and when the composite video signal has gone to about black is indicative of a commercial break in the video and audio signals from said first source.

18. The method of claim 17, further comprising conveying the video and audio signals from said second source to the at least one display device for a predetermined period of time calculated to be less than the amount of time of the commercial break.

19. The method of claim 18, further comprising switching back to the first source of video and audio signals after said predetermined period of time elapses.

20. The method of claim 13, further comprising monitoring video output of the player, and rebooting the player in the event a frozen video from the player is detected.

21. The method of claim 18, wherein the predetermined period of time is no more than about 120 seconds.
